(19) United States
(12) Patent Application Publication
(10) Pub. No.: US 2007/0183053 A1
(43) Pub. Date: Aug. 9, 2007

(54) Light absorbing elements

(76) Inventor: John Warwick Ellemor, Queensland (AU)

Correspondence Address: SHOEMAKER AND MATTARE, LTD, 10 POST OFFICE ROAD - SUITE 110, SILVER SPRING, MD, 20910, US

(21) Appl. No.: 10/599,664

(22) PCT Filed: Apr. 6, 2005
(86) PCT No.: PCT/AU05/00499

§ 371 Date: Oct. 4, 2006

(30) Foreign Application Priority Data
Apr. 6, 2004 (AU) 2004901808

(51) Int. Cl. G02B 27/00

(52) U.S. Cl. 359/613; 359/873

(57) ABSTRACT

Light shielding devices are created from opaque, light absorbing strips (39), created by coating the strips (38,39) with a, preferably, black light-absorbing coating, and arranging the strips to extend to the surface or surfaces of a transparent material in which the strips are encased, enclosed or embedded. Strips (38, 39) installed in a parallel arrangement provide a low glare collimating effect to transmitted light for either illumination or observation. Selected sides of a plurality of strips (38) may have a reflective finish such that the arrangement of the strips may either enhance the collimating effect or alternatively create a dispersing effect. Disclosed embodiments include: an overhead incandescent light shield, a bollard light shield, an overhead fluorescent light shield, a window shield, a vehicle dashboard, a pool light cover, and sunglasses.

### TECHNICAL FIELD

Herein is disclosed a method of construction and the shielding articles made thereby that will provide an observation function by causing the least interference when viewing a desired scene, subject matter or a task in hand there through. A similarly constructed shielding article can be used to distribute natural or artificial light transmitted from rearward thereof, providing an illuminating function by confining the light distribution there from to any preferred extent, the thus completed articles can also combine both observation and illumination together in a common article with both functions using it entirely, or a part or parts thereof providing individual functions.

The forgoing functions will be possible by combining just two physical opaque components, both can feature in a variety of ways, and when combined the transparent material may either be an encapsulating solid or a multiplicity of pieces or fluid in a transparent container, that in aggregate will comprise, by far a completed shielding article's major component, with the one exception being when air occupies the passageway, and then only for illumination functions. The shielding is achieved by spacing apart at suitable distances a quantity of opaque and preferably black thin and narrow light absorbent strips that will usually be supported on sheet material or alternately a single configured strip that provides gaps, the opaque and transparent components will always join together in intimate contact, thus preventing deterioration of such delicate textures that would otherwise be inapplicable in open to atmosphere shielding applications due to maintenance and cleaning considerations.

The above functions will usually require completed articles to present the thin strips as gaps, passageways or cells with their widths terminating at or near the completed article's piano and parallel ingress and egress surfaces, with exceptions relating to articles for eyesight correction, magnification or curvatures to prevent reflections, such as sun glasses exhibit,

Shielding articles that relate only to light distribution and provide an Illuminating function can make use of the transparent component's refractive properties (Snells Law), which changes direction upon entering or exiting a different transparent medium with the exception only at 90° (degrees) and where transmission continues in a straight line, thus the introduction of angles and/or curves at ingress and egress surfaces can be utilised to control the light's direction, it can bend light radiating from a point source and redirect it to exit at 90° (degrees) as for example a Lighthouse does with a Fresnel Lens. Alternately angles of absorbent black can be arranged to intercept and absorb light twice as it attempts to exit a shielding article, with the first encounter reflecting only a very small amount, followed by the balance being practically unnoticed following the second encounter and will therefore provide excellent cut off characteristics. The forgoing applications may not provide as great an output as other arrangements but will maximise contrast when concealing the source of light is of paramount importance.

The only other opaque physical component presents a reflective characteristic, that preferably is mirror and when incorporated, provides articles related to light passing through the shielding article to illuminate subject matter, it's inclusion will usually increase the light output in desired directions and will particularly suit sharp cut off in a single preferred direction, widths and angles will usually be arranged so that from a normal field of view, all observed surfaces will appear as black, when in fact the mirror surfaces will instead be presenting a reflection of a black surface. This results in utilising otherwise wasted output being used at unobserved angles to increase the light in the most desired directions.

An alternative way the advantage of presenting a mirror surface to reflect a black surface is to have them facing as explained above, but in place of the spaces and gaps being occupied entirely with a transparent component, they will instead be open to the atmosphere, the consequences being the use of more serviceable surface textures with a subsequent reflection or direct vision of the light level of the no more obscure than satin, then being observed. However this feature can still be useful for many application.

But a yet further alternative presents when the shielding article again are open to the atmosphere, but this time it can utilise an extremely absorbent black surface covered with a relatively thin layer of a transparent material, that will never the less be thick enough to present as a smooth and glossy external surface and provide many of the similar earlier described functions with the specular surface now presented, acting much like a mirror and reflecting much of the light impinging at sharp angles upon the specular surface and reflect additional light below while simultaneously allowing observation from within the normal field of view, sight through the transparent layer, the extremely light absorbent black texture below. Now in place of the spaces and gaps being occupied entirely with a transparent component, both this and previous application will present their gaps and passageway open to the atmosphere.

And finally an Absorption function will feature a thin layer of transparent material covering a single side only of thin sheet material or a more solid structure can also be provided with a substantial transparent covering with either presenting a smooth and glossy piano exterior surface, the latter incorporating a number of mirror surfaces which can be a variety of shapes, such as a layer of inverted pyramids with some of the mirror surfaces being unseen from a viewer location and reflecting the light and a broader field of radiation to prevent glare and reduce associated heat.

### BACKGROUND ART

The history of providing mankind protection from glare began well before the introduction of artificial forms of illumination, which most likely started with the control of fire, the earliest shield was the human hand and then followed one of developing humanity's most useful inventions, the development of head covering or some broad material that provided a Brim or Visor, the realisation that a cave roof or artificial structures could serve the same purpose, lead to artificial structures that provided the same shielding advantage and both the Brim and Structural Shielding remain to this day.

Observation is arguably mankind's most valued asset, absolutely everybody relies on it, even if you are blind you need the services of someone's eye sight, the present disclosure provides means to improve most shielding of glare and/or it reflections, even situations that provide the most comfortable seeing conditions such as an overcast sky can be duplicated with the elimination of reflections off near by locations adjacent to the shielding article itself and in effect an observer is unaware there is a source at all, the most important feature any shielding article exhibits is how well it reduces or eliminates Glare from either a natural or artificial light source.

How the contrast caused by direct or reflected light within the normal field of view effects an observer depends on how well surfaces absorb light, too glossy even if the colour is black it won't prevent specular glare at reflective angles, and there are problems if a light absorbent texture is difficult to clean and maintain if open to atmosphere, alternately if the shielding article is used for observation there through or provides a combination of both functions, it will have an effect on how well people can work within their environment and how comfortable they feel, when our eyes look at a task, they adapt to the brightness or luminance of that area, as our eyes leave the task and look at an area of different luminance, there is a sudden loss in the eye's ability to see contrast details in the new area until the eye can adjust to the new light levels.

An example of how the eyes gradual adjustment can provide a huge saving in power consumption is when a Department Store uses lower light levels on their upper floors and rely on your eyes adapting as you travel slowly from the Store's street level entrance and ascend to the higher levels via an escalator, the store pockets the saving in power cost, it's quite a different situation in high rise office buildings, generally all exterior walls have windows, therein lies the problem, instead of blocking them off as in the Department Store's case, they are valued by the near window occupants for the view, now you have a situation that those nearest the windows want them to observe the view outside, while those furthest away want the blinds drawn so the light level will be sufficient to provide a similar level of light at their desks without suffering glare etc; so too bright at the window means light in excess of adequate requirements, this can also mean more power than necessary is consumed.

This disclosure provides answers related to this problem and many other such problems. Glare and/or it's reflections can be created either from artificial light sources such as incandescent, fluorescent and a wide range of gas discharge sources or from a natural light source, these and many other primary sources of light within the normal field of view have in the past, been dealt with in many ways, shielding has been effected by a covering for one's head, Vehicle Sun Visors, Window shades such a Venetian blinds that can be drawn down to a required length to suit circumstances and all manner of shielding articles attached to Lighting Fixtures are just a few examples.

One common form of luminaire to suit a fluorescent source, comprises a recessed or surface mounted ceiling light fixture which incorporates a fluorescent light source mounted rearward of a shielding device known as an ?gg-crate′. This form of shielding device comprises a plurality of longitudinal strips and a plurality of intersecting transverse strips which are spaced from the light source, the surfaces of the strips are often of a pale grey or a colour to suit the ambient light level, and feature a texture no more light absorbent than a satin finish, particularly when used open to the atmosphere to reduce cleaning requirements.

Another form of light shield commonly used with fluorescent light sources comprises a sheet of clear plastic featuring a prismatic configuration, whilst such sheets do transmit a high proportion of light in a vertical direction, they still present a considerable level of glare, particularly at the junction of prisms and where angles meet. A thin black insert terminating at junctions of the prisms could eliminate this observation.

Yet another shielding device which achieves such low glare characteristics that it presents little indication that a light source within it is switched on, comprises a panel usually moulded of plastic and having a plurality of individual square cells which have mirror finish concave surfaces on all four surfaces of the cells, panels of this type present an unlit surface appearance because, an observer's normal field of view reveals a concave mirror surface which in turn reflects the scene below in another concave sector, in one such shielding article, each single cell provides a 10 mm×10 mm area for light to enter and in order to accommodate the concave shape, the cell uses a 15 mm×15 mm area of the lighting shield to exit, meaning that less than half the light available from inside the luminaire can exit directly, similar shielding article are also made of a reflective sheet material such as anodised aluminium.

In the case of naturally occurring light, for controlling daylight entering a building through windows, various forms of blinds and shutters are usually employed and mounted adjacent to the windows. Venetian blinds are one such form used for this purpose and comprise a plurality of slats whose angle to the horizontal may be varied to control light transmission through the window. The slats of the blind however being exposed to the atmosphere collect a great deal of dust, they also present annoying reflections from the glossy and usually lighter colours, the slats are also often of a. lightweight construction which have to be curved for strength and this results in a wider interruption of the view through the window, further the slats often have a gloss surface which means that direct sunlight will reflect from some point on the curve if they are positioned near to horizontal, and thus looking through them distracts one from enjoying the view.

Another product that relates to natural lighting comprises of a sheet of transparent material featuring narrow voids which are open to atmosphere and are cut partially or all the way through the sheet material, usually by means of a laser and incoming light is reflects from the surfaces of the cuts, this product is usually used in skylights or for replacing shielding devices attached to windows, surfaces formed by the cutting reflect much of the light, and no shielding is provided to prevent scattered light interrupting the view through the panel.

Other lighting by artificial means covers a huge range of products, applicable to nearly all human activities, particularly but not exclusively after sunset and includes Highway and Residential Road Lighting as well as sports and recreational lighting including lighting for Stadiums, Bowling, Entertainment, Tennis Courts and safety applications including Pathway Security lights, Garden lighting both Up lighters (flush with the ground), Post Top lanterns or Bollards and all manner of Domestic activities, Work situation lighting covers many indoor applications including, Office and Hospitality lighting, Commerce, Merchandising, Medical, Manufacturing, and the safety aspects of work with Machinery. In many situations current luminaires lack sufficient directional control and create unwanted glare with little if any effective shielding being used and many luminaires operating near Computer Screens or above high gloss or white surfaces that reflect high light levels back to the user, interfering with the tasks in hand.

The present disclosure provides answers to many of the foregoing problems taking advantage of reflective surfaces concealing yet adding a higher output in useful directions. It can provide absorption never before permanently achieved and present secondary reflections so unobtrusive that near by exposed surfaces won't provide any indication where the source is located and create a situation as comfortable and relaxing as an overcast sky and present viewing situations without shadows.

### SUMMARY OF INVENTION

This disclosure is based on the properties exhibited by the two opaque physical surface characteristics this disclosure features, the first being a unique extremely light absorbent black surface, it can alternately be a colour or hue to suit a particular situation or to suit an ambient level of light, but will be black for maximum obscurity, prior to this disclosure few surfaces could exhibit such an absorbent property, although black velvet goes very close when exposed to the atmosphere and wherein individual fibres present at non reflective angles with reflections and/or observation going deeper into its fabrication, unfortunately it's impracticable for use exposed to the atmosphere.

The second physical surface characteristic is a Mirror, It is not possible to see a piano surfaced mirror, you are aware of it's presence announced only by edges and junctions providing a change in contrast or by movement or a scene inconsistent with a viewed area, which includes seeing one's own reflection, with the introduction of this disclosure it now means a black surface can be almost as efficient in concealing it's presence as a mirror is at reflecting and now neither encapsulated black used alone or an encapsulated black combined with a reflection of black will be easily observed while these same mirror surfaces disposed at concealing angles will redirect previously annoying glare in useful light enhancing directions.

The aims of this disclosure, outlined earlier in the Technical Field are to produce shielding articles by configuring at least one or combining a number of thin opaque usually piano components spaced apart at substantial distances relative to their thicknesses and in the majority of applications being linier, usually of a constant width and presenting as parallel to one another, their widths in most cases will be horizontal when applied to observation there through or when applied for illumination both vertical, horizontal and any angle in between, with components spaced apart at distances and often at a diagonal angle to fulfill a required shielding function.

The first and only surface characteristic that features in every single aspect of the invention is a light absorbent opaque surface that for the least possible observation, preferably is black with a texture as light absorbent as the particular application allows, it can present on the both sides of thin physical supporting component and when one or a quantity are the only opaque surfaces featured. It can be combined with a solid or fluid transparent physical material and is the only combination in the disclosure that presents articles for observation through the shielding article, but it can alternately be applied either for illumination of subject matter alone or articles that combine both transmission functions. It can also be used for illumination application beneath a thin layer of transparent material thick enough to provide a smooth and glossy surface that can alternately use specular reflections or depending on angles used can absorb light in the extremely black light absorbent surface beneath, with the gaps or passageways thus created being exposed to the atmosphere.

An alternate surface characteristic, that is highly reflective and preferably a Mirror surface is the second and only other opaque surface used in the disclosure, with its introduction the range of products for light to pass through is greatly extended, in addition to mirror combining with a black light absorbent component being separated entirely by a substantially thicker transparent component in intimate contact and providing the means of light transmission and wherein refraction and/or shaped ingress and egress surfaces can also conceal or direct the additional light output.

A combination of mirror and black components can alternately combine with gaps and passageway separated by air alone (open to atmosphere) and although this will necessitate that the black surface can now only present a less desirable satin texture, it's mirror reflection facing opposite will allow a higher light output to be selectively directed, while within the field of view only black or it's reflection will present.

The final way that a mirror can be combined with an extremely light absorbent black texture is when the black component is covered with a thin layer of transparent material applied thick enough to provide a smooth and glossy surface and utilise it's specular reflections, it's gaps and passageways will be open to the atmosphere and it's principle advantage will be the much higher light output, a selected direction may be required and will be very good to use in out of sight locations.

A great many combinations can apply when assembling the shielding articles including, Mirror can present on one surface of a single thin opaque, component and it's reverse side can feature as a Black surface, either one or any number can combine to be configured or arranged to present as a completed Shielding Article. Another alternate combination of physical components can present two Mirror surfaces back to back, but will usually only be used in conjunction with a Black surface or a quantity of Black surfaced back to back components joined opposite one another across Gaps and presenting parallel to one another or Passageways created when the above components are joined by transverse components at 90° (ninety degrees) or any number of alternate angles, the arrangements can further be inclined at many angles relative to transparent materials external surfaces, combinations can alternately take the form of a number of triangular Passageways that either combine two Black and one Mirror or two Mirror and one Black or can present Square or Rectangular four sided passageway wherein Black and Mirror can present two adjoining Black surfaces facing two adjoining Mirror surfaces. The disclosure applies equally to many other configurations, such combinations are arranged at angles and spaced to provide a viewer within the normal field of view, either sight of a black surface direct or a reflection of a Black surface.

A further advantage can be that when a common refractive index presents, as would be the case when a thin lightly pigmented Acrylic component is so lightly tinted with a black pigment that it's finally dense enough to become opaque, it then combines in intimate contact with a thicker Transparent Acrylic component and their common refractive index will prevent the junction providing specular reflections.

A yet further advantage is the ability to present surfaces at angles or shapes to improve directional capability. Opaque components for illumination functions can present in many different shapes either symmetric or asymmetric, in most applications they will usually be thin linier strips and suitably span the entire cross sectional wall or panel thickness of a Transparent material that when used as the means of transmission constitutes by far the shielding article's greatest volume, it thus presents wide gaps and or passageways joining in intimate contact by being sandwiched as alternate layers, being encapsulated within, being produced by co-extrusion or being a surface treatment applied to the physical transparent material.

An aspect wherein an observer views external subject matter from within a fixed structure or out of all manner of transport, through a shielding article composed of a number of thin opaque horizontal long components displaying an extremely light absorbent black surface on both their upper and lower surfaces, spaced apart at distances and angles to limit vertical observation there through by being in intimate contact with alternating layers of a considerably thicker Transparent material and thus protecting a texture so delicate that it would be impractical for use in open to air situations, the spacing is usually arranged to restrict vertical observation and reduce the contrast between a desired viewing sector and the glare of a bright sky, articles so constructed substitute for glazing or are attached adjacent to Windows. The foregoing observation function will usually allow sufficient light to enter during the day without admitting high levels of glare, it can combine to also admit greater and controlled levels of light when the components above head height still feature their underside surfaces as absorbent Black but will present a mirror surface and be inclined to direct incoming light towards ceilings inside the structure and thus present an overall more even lighting outcome, the Black and transparent combination may also present as a shading pair of Eye Glasses, Snow Goggles or a Sun visor, that in addition to usual view looking forward, is able to swivel to a vehicles side window and be inclined to prevent annoying sunlight flashing in ones eyes when passing a number of poles or trees, yet permit up to just above the horizon to still be observed. Another application and when vertical and horizontal black shielding components combine, spaced apart at suitable distances and encapsulated within a transparent solid material, constructs a shield through which a self illuminated Camera View Finder can be observed, it presents for view as a very shallow concave surface with a similarly curved and parallel convex opposite surface that from a normal viewing position provides specular reflections from only a very limited field, this configuration is one of the few observation there through applications that don't require piano and parallel exterior surfaces.

To these same methods of construction must be added a great variety of shielding articles that present to transmit Light there through, with configurations now able to extent the range of external shapes beyond the parallel and substantially piano surfaces and suit directional capabilities that the transparent materials refractive properties present at all angles other than at 90° (ninety degrees) to a surface and in addition, the change of angle light assumes upon entering a parallel surfaced panel resumes the same angle upon exiting.

A refractive advantage presents, relates only to Lighting applications because the refraction at all angles other than a 90° to both exterior surfaces or angles of transmission causing changes of direction when exiting non parallel sections provide further directional control, for example if a Fresnel Lens presents with Black absorbent components extending to it's prism's external extremes, shielding will be so effective that observation will extend little beyond the width of the beam itself.

Another advantage refraction presents, relates to section's of a shielding article featuring parallel transparent ingress and egress surfaces, this allows articles to be constructed wherein a number of thin Black components are arranged at angles, usually extending to or near the transparent material's exterior surfaces, that never reveal the source of illumination in a direct line and when the Black component's widths and the distances separating them are positioned to present a cut off so the luminaire's output remains unseen from a specific location or requires a conscious effort to be observed from within the Normal Field of View, the source can be so well concealed that an observer only becomes conscious of the luminaire's existence by a higher contrasting level of light being observed illuminating nearby objects that contrast with the surrounding ambient light level.

The following two examples detail how a shield for a Bollard Lighting fixture can be constructed, the first takes the form of a hollow cylinder of clear Acrylic transparent material in which are encapsulated a number of very thin walled frusto conical sections of absorbent material with all shielding surfaces being Black with an extremely delicate texture providing never before achieved levels of concealment and permanent protection and spaced at distances calculated to provide a precise cut off angle just below horizontal, all of the light entering the transparent ingress surface at angles inclined downward will bend due to refraction and pass through to the egress surface where it will resume it's entry angle, this will present a well lit area close to the base, light that enters the transparent components ingress surface and is aimed above horizontal will be redirected by refraction and be intercepted by the black underside and will practically be all absorbed upon contact, what little then reflects off this first surface will present at the opposite absorbent surface on the upward facing surface of the component immediately below and be further reduced to such an extent that the amount of Light exiting the shielded article above cut off will barely even be noticed directly except perhaps as a silhouette against it's surrounding self illuminated background, the light absorption in both upper and lower surfaces will result in a reduced light output because the only exiting light requires a direct passage for transmission at the refracted angle, but in both this constructed version of a bollard and many other applications shielding the source entirely from sight is the prime objective.

The second configuration introduces a 'Mirror1 surface and presents as a similar assembly to the above Bollard, but instead of the underside of each conical section featuring both upper and lower surfaces as Black it instead presents a Mirror surface unobserved above horizontal, the Transparent enclosure of a Black texture in intimate contact, still means it is extremely light absorbent but because it no longer is absorbed twice it allows the light lost in the previous example to be redirected and thus greatly increases light output, all be. it at the expense of a now slightly more easily observed source.

The above two Bollard alternative methods of construction could easily be repeated for a great number of products related to illumination, both those within the normal field of view and that can be required to also remain unnoticed when obscurity is the major aim. Or alternately. Articles used when a very low light level of observation can be tolerated and the trade off can result in a much increased light output by it being reflected it in a mirror surface that faces a very light absorbent black surface across a physical transparent material.

Another article is a non transmitting application that fulfills an absorption function, and would shield a vehicle's driver from ‘Glare, either Blinding, Direct, Disabling or Discomforting’ caused when travelling towards the Sun or other high contrast situations, the material used is composed of a single piano layer of Black absorbent material, intimately joined to a solid Transparent external material, the shielding article presents as two sections that join at an acute angle, arranged so that either surface presents only a reflection of the other. The first section extends from just beneath the windscreen and at a lower point joins the second section that constitutes the vehicles Dashboard, thus when observed from a driver's seated position, it prevents any possibility of ‘Glare, Reflected’ or ‘Glare, Veiling’ creating a distraction, the thus created sheet material could be subsequently thermo formed to suit a particular contour.

A similar article that can be fabricated from a number of thin sections of the above combined non transmitting material to construct a Camera Lens Shield, it could feature a re-entrant opening shaped at angles to prevent specular reflections from interfering with the desired photographic results. One suggested method of construction can be a combination of a transparent solid such a an Acrylic plastic sheet combined with an alternate Acrylic sheet that has been pigmented with a black material so well dispersed that it only becomes opaque gradually and because both sheets share a common refractive index their junction presents no specular reflection, many other Black surfaces can combine in a similar fashion, such fabricated sheet material could also be shaped by being formed, either by mechanical means, by vacuum or pressure.

A further example referrers to an alternate Dashboard construction that physically is the same as the earlier described example except the dashboard now introduces the black section as a single layer composed of a number of inverted pyramids and where mirror tri-angular sections combine with a number of Black shaped tri-angular sections their orientation presenting the Black sections to a driver, while the mirror surfaces are arranged at angles that reflect light out through the windscreen in unobserved directions, while parts of mirror that are observed by the driver present only Black reflections as is the case for four sided pyramids or. for three sided pyramids when used with a suitably sloped windscreen.

An alternate method of construction to the foregoing examples associated with illumination functions that would still allow an absorbent texture to be achieved and in addition be less expensive, by providing the Black surfaces with a transparent layer just thick enough to present a smooth and glossy exterior surface and thus allow a through air transmission to apply, the specular surfaces thus created would reflect a great amount of the light at low angles of incidence, with while at angles within the normal field of view much less reflects and the layer reveals the black surface beneath, act much like a mirror surface and reflect light at predictable angles, while at other angles the transparent layer will reveal a light absorbent black surface, many products will be constructed by one or a number of such parts combine to present a complete shielding article.

Another application that can utilise a light absorbent surface covered with a layer of transparent material, relates to a recessed ceiling mounted luminaire located close to and parallel to a wall that is displaying paintings. The shielding article is provided with thin metal strips located beneath, oriented longitudinally and parallel to it's fluorescent tube light source, arranged at suitable angles and spaced apart with the spaces thus created exposing specular surfaces open to the atmosphere, the surfaces nearest the wall and all featuring mirror surfaces, while all the reverse side's surfaces will display the enclosed Black textured surfaces,. The transverse strips that are spaced at distances equal to the longitudinal strips can alternately present as all black or one side black and the other mirror, the luminaires will be mounted close enough to the wall and angled so that one's back would be to the wall to observe exiting light. A similar unit constructed using Transparent material, will improve light absorbent surfaces and also gain a number'of refractive advantages.

A further application that can be installed out of sight, within a wall Sconce or Cove that could be narrow enough to even provide the means to suspend paintings there upon, the recessed cavities (Sconce) will house very narrow fluorescent lamps, above the lamps but beneath the upper edge of the sconce or other structures that conceal the thus unobserved source from floor level are a number of clear Acrylic shielding strips in which are arranged a number of thin strips encapsulated within, arranged at angles that would prevent the wall immediately above from receiving a high level of light and that on the wall facing side will present an extremely light absorbent surface. Such a product can also present in many locations such as alongside the lower edge of exposed beams and where the blocked and completely utilised light output will not reveal the nearby surfaces of the beam as they will be shielded, the existence of the light will not be notice as it is so well diffused upon the angled Ceiling above, such an assembly could be totally encapsulated and in addition to the refractive advantages provided,, it would present an easy to clean panel or a thin transparent coating could apply to just black or a combination with mirror and present gaps or passageways open to the atmosphere.

Another application presents a skylight, light emitting panels are used on multi-faceted shapes such as a three sided pyramid may be assembled from transparent panels, each incorporating thin opaque components, that are reflective on one surface and light absorbent on the other surface. The angles can vary in cross section and/or longitudinal according to requirements at different latitudes which can require early and late in the day high light input and a limited input during the centre of the day's heat or a day long constant input. An assembly of this form is preferably mounted upon a circular shaped mounting section, so as to be capable of rotation about a vertical or near vertical axis, so that in one application it is capable of being oriented so that one panel faces towards the pole in the hemisphere in which it is located with either a third light admitting panel or a configured sheet that re-reflects incoming light from the other panels downwards. The two panels positioned adjoining the equatorial facing corner would enable, particularly toward the higher latitudes, admittance of light from the East and the West. Alternately the reflective surfaces can be positioned to limit the light and thus heat input during the middle hours of the day in higher temperature locations to present a more comfortable situation.

In addition, examples of excellent cut off shielding and using the reflected component to maximum advantage can relate to a game of tennis after dark,_wherein by applying this disclosure, light from both ends can provide a cut off so a player will not sight the opposite end's light source even when standing next to the net, while lights installed at each end of the net will illuminate the wedge shaped, otherwise dark area above head height.

The cut off advantage can also relate to under water lighting for Swimming Pools, providing Glare free conditions for those relaxing around the pool by exposing them only to light diffused under water sectors, the light shields can have their shielding components angled and the refraction of the shields in combination with the refraction of the water arranged to only be observed by diving under the pool's surface. These examples and many other applications, prevent Glare disabling or Glare discomfort annoying those exposed and where Sharp cut off and/or selectively directed additional light vastly improves viewing conditions.

### BRIEF DESCRIPTION OF THE DRAWINGS

In order that the invention may be more readily understood and put into practical effect, reference will now be made to the accompanying drawings which, illustrate preferred embodiments of the Invention, however it will be appreciated that the illustrated embodiments are only examples of the articles to which the principles of the present invention may be applied.

In the following drawings:

FIG. 1 Is a perspective view from the underside of a light fitting incorporating a light shielding article according to a first embodiment of the invention;

FIG. 2 Is a cross sectional view of the light shielding article of FIG. 1;

FIG. 3 Illustrates an exploded somewhat schematic view of a further form of light fitting incorporating a shielding device according to a further embodiment of the invention showing only some of the shielding and transparent parts including a fluorescent light source;

FIG. 4 Illustrates in a cross sectional view of a section of a light fitting of the type shown in FIG. 3 comprising a plurality of shielding and transparent parts in a configuration arranged for use including an incandescent source;

FIG. 5 Illustrates an exploded somewhat schematic view of a further form of light fitting incorporating a shielding device according to a further embodiment of the invention showing only some of the shielding members including a fluorescent light source;

FIG. 6 Illustrates in a cross sectional view of a section of a light fitting of the type shown in FIG. 5 comprising a plurality of shielding parts in a configuration arranged for use together with a fluorescent source of light;

FIG. 7 Illustrates in perspective view and from the underside, portion of an “egg-crate” shielding device according to a further embodiment of the invention;

FIG. 8 Illustrates in perspective view and from the underside, portion of a shielding

FIG. 9 Illustrates in perspective a view of a further embodiment of the invention comprising a shielding article for use as a window or adjacent a window;

FIG. 10 Is a sectional view of portion of the panel of the shielding article of FIG. 9 showing the dual functions of light transmission and observation there through, in which the lower sector consists entirely of light absorbent surfaces, while the above head height upper sector features upwards facing mirror surfaces to direct exterior light at angles to illuminate areas deeper within the structure, while their undersides feature surfaces that absorb light;

FIG. 11 Reveals a perspective view of the opaque components that combine an absorbent only function sector with a sector that contains reflective components to produce a vehicle dashboard;

FIG. 12 A cross sectional view A. A. indicated on FIG. 11 provides a sectional view of the inverted Pyramids that combine Black absorbent sections and mirror sections and shows Transparent sections on the Absorbent only components of FIG. 11. the transparent material has a smooth surface that extends downwards to occupy the Pyramids; FIG. 13 This illustrates cross sectional view B. B. and provides a view downward that displays the configuration with the absorbent surfaces illustrated as black and the mirror surfaces white. FIG. 14 This presents a similar cross sectional view as illustrated in FIG. 13. the principle differences being, four sided pyramids apply and all utilise two black and two mirror surfaces and further the absorbent only near vertical section now extend as a number of triangles at the junction as it applied in the FIG. 13 version.

### DETAILED DESCRIPTION OF THE PREFERRED EMBODIMENTS

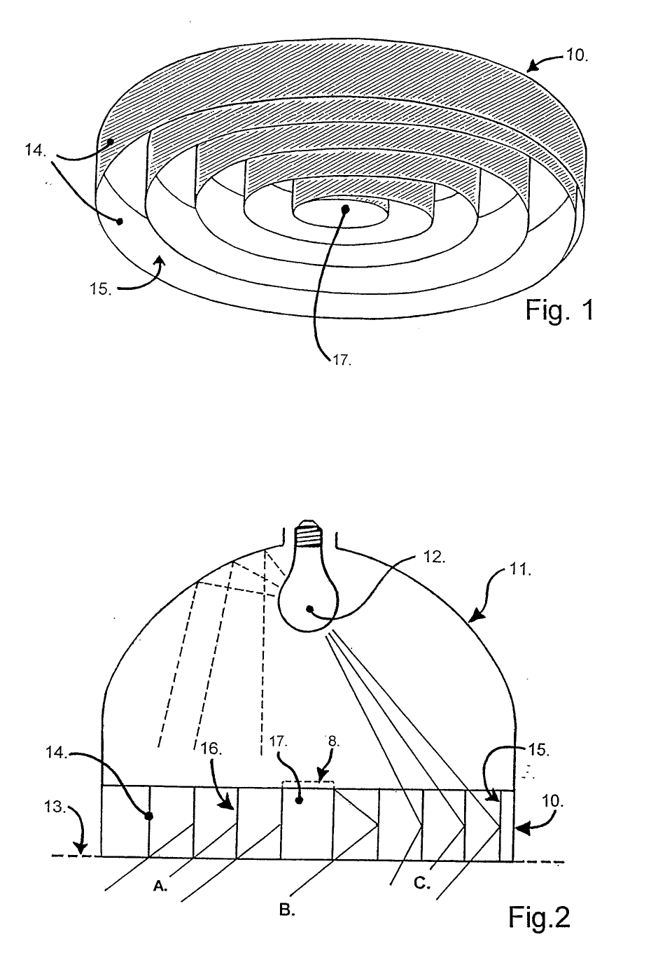

FIGS. 1. and 2. illustrate one application of the invention in the form of a light shielding device 10. in a recessed light fitting 11. having a conventional light source 12. which for example may be an incandescent lamp and which is supported rearward of the shielding device 10. The body and fixing details of the light fitting 11 are not shown. The light fitting 11. may be mounted in or on a ceiling, wall, floor or other surface and most suitably is recessed such that the lower edge of the shielding device 10. is flush with the surface 13. of the ceiling, wall or floor (shown in dotted outline). The shielding device 10. is formed of a single length of strip material 14. suitably of aluminium which is formed into a spiral shape such that the major dimension of the strip is parallel to the plane containing the central axis of the spiral and substantially normal to the surface 13. The strip material 14. has on its inner face 15. that is facing towards the centre of the spiral, a reflective surface formed for example by a mirror finish and on its outer face 16. a light absorbent and preferably Black surface for example by having a satin finish. At the inner revolution 17. of the spiral, the reflective or mirror surfaces 15. face each other and will reveal the light level inside the light fitting. To prevent this occurring, a cap 8. shown in dotted outline in FIG. 2 may be incorporated to shield the light source 12. from view. In the configuration illustrated, an observer viewing in the direction A in FIG. 2 in the normal field of view will see light absorbent surfaces 16. Viewing in the direction B of FIG. 2. an observer will see in the reflective surfaces 15, a reflection of the light absorbent surface 16. The light source 12 will thus not be apparent to the observer in most normal positions of the observer thereby reducing glare from direct observation of the light source 12. Further, light intensity beneath the light fitting will be increased due to reflections from the reflective surfaces 15. as examples C indicate.

In an alternative arrangement, the reflective and light absorbent surfaces 15. and 16. are reversed such that the reflective surfaces 15. face to the outside of the shielding device 10. which will produce a broader distribution of light by reflections from the light source and as a consequence cap 18. will no longer be required. The light fitting 11. described above is shown in the configuration of a recessed ceiling fixture however it will be appreciated that the light fitting 11. may be installed in a wall or alternatively inverted from the position of FIG. 2 and installed in a floor or in the ground such that the light fitting 11. is substantially flush with the floor or ground surface.

Further the strip material 14. is wound into a spiral form with air separating the reflective and light absorbent surfaces. The reflective surfaces 15. and light absorbent surfaces 16. are thus preferably created with surfaces that do not deteriorate when exposed to the atmosphere and thus may require a surface texture no more absorbent than a satin finish. In an alternative arrangement, the spiral strip material 14. may be encapsulated in a solid transparent material which will provide protection for the reflective and light absorbent surfaces 15. and 16. and allow extremely light absorbent textures to be used. Such a configuration is particularly suitable for use in situations where the light fixture is required to be installed in the ground for example in a path, driveway or to illuminate the upper sections of trees. The finally assembled transparent material may have parallel surfaces on each side or alternatively feature a spiraling prism angled to direct light in preferred directions or alternately a curved surface may be used to narrow or broaden the light distribution. This construction left exposed to the atmosphere may alternately present a thin transparent layer, (not indicated on the drawing,) and present a very light absorbent surface below.

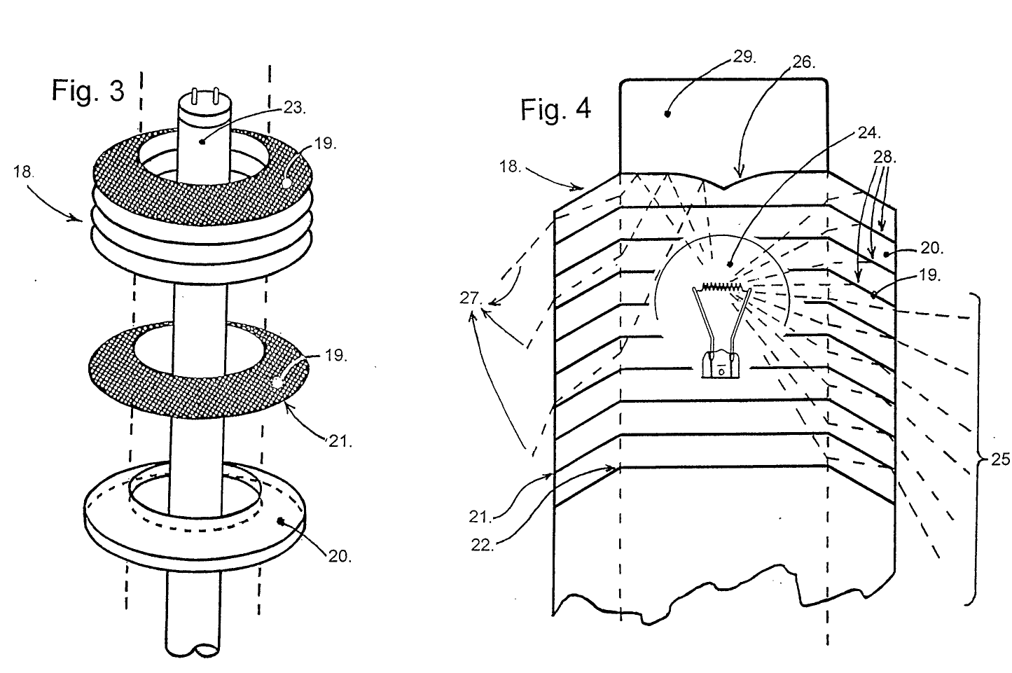

Referring now to FIG. 3. there is illustrated a some what exploded view of lighting fixture 18. known as a Bollard particularly but not exclusively suited for exterior use. A further illustration FIG. 4. shows a cross sectional view of 18, comprising alternate light shielding components 19. that feature thin light absorbent and preferably black on both it's major surfaces and considerably thicker transparent components 20. The outer lower edge 21 of each shielding component 19 is lower than or at a similar level to the upper inside edge 22 of the immediately lower shielding component 19. The components 19 and 20 in this embodiment are of a generally frusto conical 0 configuration and surround a light source 23 which may as shown in FIG. 3 comprise a fluorescent light source or alternately a source as shown in FIG. 4 where the incandescent light provides a more concentrated source 24 is illustrated schematically, light rays 25 from this nearer to a point, light source and 24 therefore provide easier to illustrate directions, showing how they are refracted as they pass through the transparent components 20 as shown in dotted outline and upon exiting the transparent components 20 resumes an angle equal to their original angle of incidence. The foregoing angles are based on the refractive index of Solid Acrylic Sheet (PMMA).

It will be apparent that the configuration of shielding members 19 of the light 0 fitting 18 prevents the light source 23 from being observed other than from angles below the horizontal. Thus if installed for lighting along a path at a low horizontal level, the light source 23 will never be observed above horizontal on the level pathway. A cover 29 may be provided above the light source 24. FIG. 4 also illustrates a reflector 26 for example formed on or by the cover 29 and the reflected light presents exiting beams 27. Light beams 28. indicate angles that upon striking the underside of shielding component 19 are almost entirely absorbed, with what little that does reflect then being absorbed a second time on the below black surface, thus light beams 25 fulfil the principle objective of illumination without observing the light source either directly or reflected,

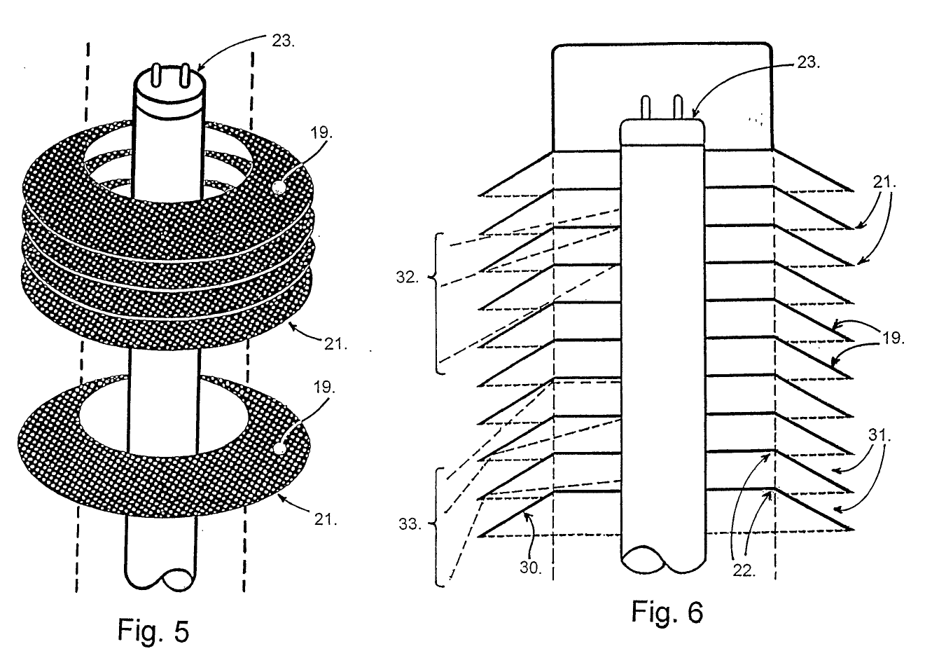

FIGS. 5 and 6 illustrate a similar form of Bollard lighting fixture 27. to that of FIGS. 3. and 4. Bollard light fixture 18. as it is also composed of a plurality of thin spaced apart frusto conical physical shielding components 19. which surround a fluorescent light source 23. These components 19 may be light absorbent and preferably Black on their upward facing surfaces with their undersides having a reflective mirror-like finish 30. to reflect the light output from the light source 23. As in the embodiment of FIGS. 3. and 4. the light source 23. cannot be observed other than from angles below the horizontal and the outer lower edge 21. as each shielding component 19. is lower than or at a similar level to the upper inside edge 22. of the immediately lower shielding component 19.

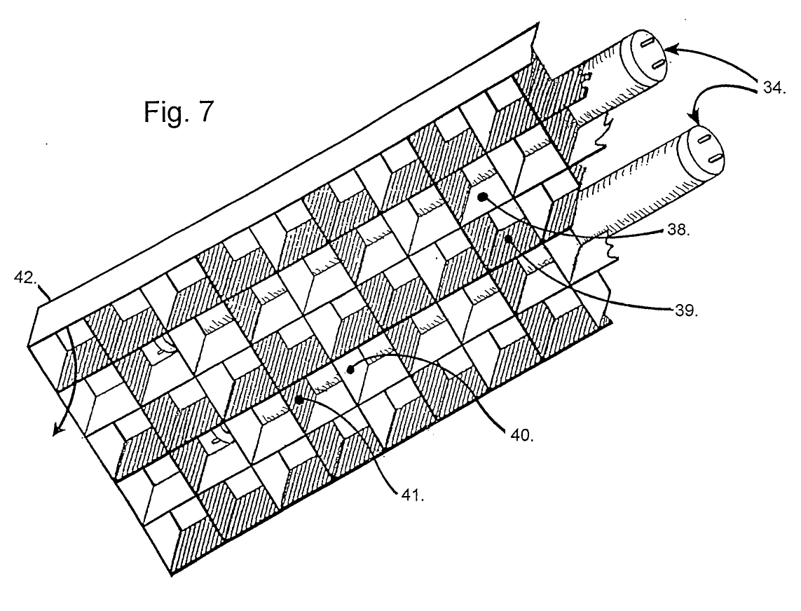

Light fixtures 18. and 27. of the type described and illustrated with reference to FIGS. 3. and 4. and FIGS. 5. and 6. may be used as a bollard or other guiding light or beacon in a garden, along a path in any other application and of course the angle of inclination of the shielding member 19. may be varied to suit different applications. The construction provides structural members (not indicated) to space shielding components 19. apart with voids 31. left open to the atmosphere and thus preventing use of an extremely absorbent texture due to cleaning and maintenance considerations the surface finishes will usually be no more absorbent than a satin finish. A number of light rays 32. indicate angles light passes through the components 19. uninterrupted, while light rays 33. indicate reflected directions that provide light nearer to the Bollard's base. Although the advantage of mirror reflective surfaces opposite absorbent surfaces provides a higher output than an overall common surface, this configuration lacks the advantage that a solid or fluid transmitting material provides when refraction allows the entrance angle to be resumed upon exiting and lacks the hiding ability that extremely light absorbent surfaces in intimate contact with a permanently protective transparent material presents. Although it is not shown in the drawing, a thin layer of transparent material could alternately apply. FIG. 7 presents an isometric illustration showing part of a shielding devise 37. usually referred to as an “Egg crate” it is composed of a plurality of thin strips 38. having reflective and preferably Mirror surfaces on both major sides. While similar physical strips 39. feature a light absorbent texture, preferably a Black surface on both sides but in the illustration featured as grey and striped for clarity. Strips 38. and 39. presenting their alternate surface finishes parallel to one another with both also being parallel to the fluorescent light sources 34. A like arrangement presents Mirror strips 40. and Black strips 41. also with alternating surface finishes extending substantially at right angles to.-strips 38 and 39. and when the “Egg Crate” is employed on a horizontal plane, all strips will be spaced apart at suitable distances vertically so as to present a series of rectangular or square cells or passageways 42. each with an adjoining pair of reflective piano sections, facing a similar sized pair of light absorbent sections, the thus spaced components present within the normal field of view, alternately a Black surface or a mirror surface that reflects a Black surface with the mirror surfaces also directing useful additional light at unobserved angles. Such a configuration provides a symmetric light distribution pattern, governed only by the orientation of light source. An alternate transparent layer (not indicated) could allow a more absorbent black surface to be used.

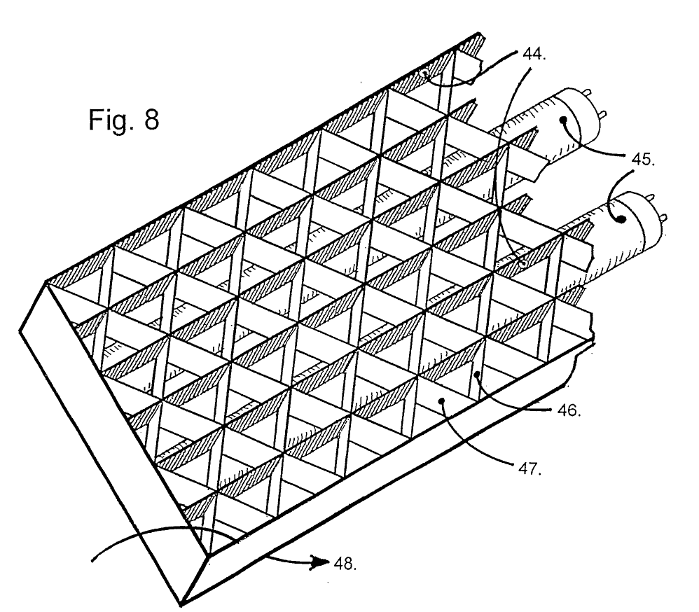

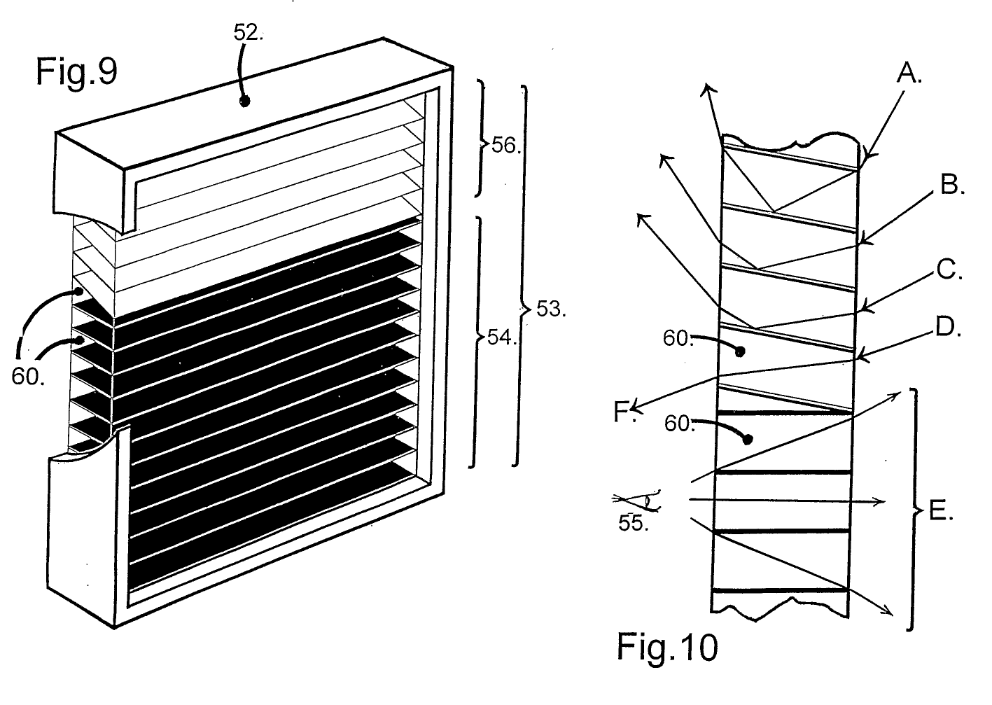

FIG. 8 illustrates a further form of light shielding device 43 which is also in the form of a shielding devise that performs in a similar fashion to the ?gg Crate″ 37 of FIG. 7. This present device 43 includes a plurality of longitudinally extending substantially parallel thin strips 44 having light absorbent preferably Black surfaces on both major sides but in the illustration featured as grey and striped for easy recognition, their major dimension being substantially parallel to the fixture's fluorescent light source 45. Further strips 46 and 47 similar dimensionally to the afore mentioned Black strips 44, 0 except they feature a reflective and preferably Mirror surface on both major surfaces. Assuming that the shielding device 43 is supported substantially horizontally in or upon a ceiling, all strips 44, 46 and 47 lie in substantially vertical planes. The strips 46 and 47 which intersect the strips 44 form a series of equilateral triangular cells 48. with each such cell combining two reflective surfaces and one light absorbent surface and provide passageways for the exiting light.

In the normal field of view of an observer, only a light absorbent surface 44 which in the illustration is striped, will be seen either directly by looking at a surface of a strip 44 or indirectly into either of the mirror reflective surfaces 46 or 47 as a primary or ? in some directions as a secondary reflected image of light absorbent surface 44. Thus 0 glare is reduced and as a further advantage the above described configuration also increases light output in a longitudinal direction and thus providing a vastly superior symmetric light distribution. In a similar fashion to FIG. 7, not shown is an alternate thin transparent layer.

Alternate arrangements to the open to air shielding articles featured in. FIG. 7 and FIG. 8 that would greatly extend the range of products is the inclusion of a transparent material occupying the entire cavity in place of the open to atmosphere voids, external surface shapes could apply, much more absorbent surfaces would better conceal the light source and weather proof and even under water lighting fixtures could result. Angled black and mirror could result in excellent cut off characteristics, 0 providing directional illumination with very high efficiency.

FIGS. 9 and 10 illustrate a further application of the invention comprising a shield assembly particularly applicable to windows which may take the place of glazing or alternatively be used adjacent a window. This shielding assembly comprises a small rectangular external frame 52 which surrounds a piano panel 53 which includes a number of thin light absorbent and preferably black shielding components that feature on both their major surfaces 54 and usually present only below head height and being in this embodiment substantially horizontal. The sketched eye 55 indicating at or just below head height and when an observer is located close to the panel, showing the maximum observable range terminating as letter E. Panel sector 53 also incorporates an additional number of thin piano components 56 located above sector 54 that retain a light absorbent surface on their lower facing sides but now utilises a reflective and mirror like surface upon their upper surfaces, the drawing presents 56 as a double line in FIG. 10, you will note they are arranged at angles to suit a particular location which in this case is a sub-tropical latitude, it is oriented to suit a required internal light distribution, the input indicates random directions A, B and C indicating angles of incidence that first refract and change direction upon entry, will reflect on the internal mirror surface and again refract upon exiting, such an arrangement covers a broad sector of the sky.

Input D. indicates a lower input angle that transmits, changes direction in transit due to refraction and then recommences it's original direction, such light will expose a lower sector of the sky to an observer deeper within the building while at the same time adding to the light level admitted by directions E and F. Sector 54. thus combines observation, providing only a limited vertical exposure while also admitting a reduced level of light for those located close to the window, and when this combines with a further light input redirected following reflecting during transit between sectors of 56, the overall contrast is reduced. The respective physical shielding components in FIGS. 9 and 10 as items 54 and 56 are spaced apart at suitable distances and are encapsulated, co-extruded or joined in a variety of ways, by transparent materials which in the illustrated example exhibits the refractive angles appropriate for the solid Acrylic components 60.

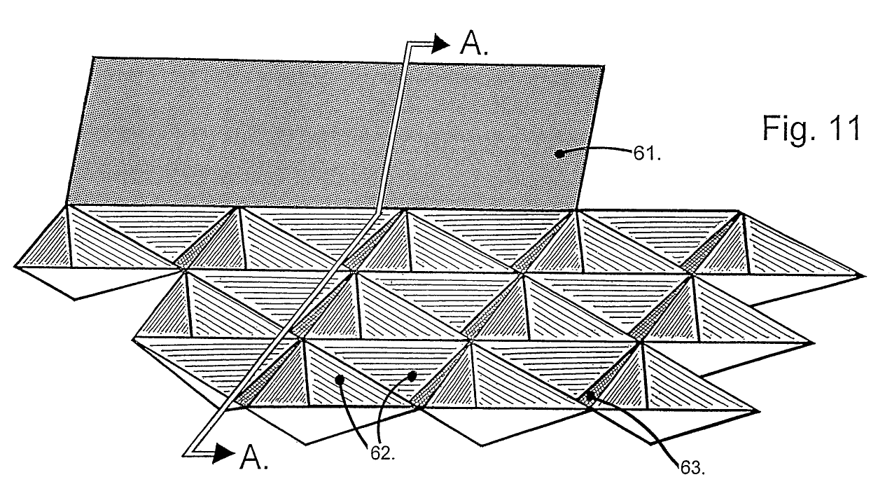

FIGS. 11. 12. 13 and 14. represent different views of a non transmitting application of the disclosure, the product is a vehicle dashboard and incorporates a small shielding strip 61. forward of the dashboard and mounted at an acute angle to prevent specular reflections. FIG. 11 presents just a small section of the whole article and is viewed from a drivers seated position. The major area of the dashboard is near horizontal and is composed of a number of inverted three sided pyramids, the shading 62. indicates the light absorbent black sectors with the shading lines all horizontal. Mirror sectors 63. are cross hatched and usually will be seen only when looking other than straight ahead and in reality they remain unnoticed as they reflect a black absorbent surface to the driver, a transparent covering layer that also occupies the entire pyramids is not shown, cross section A.A. will reveal it later.

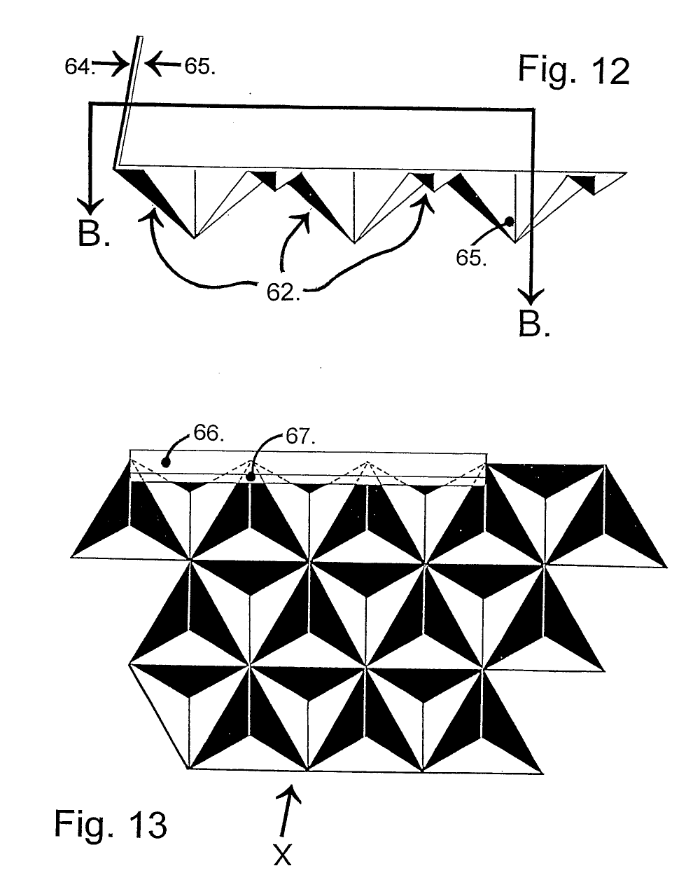

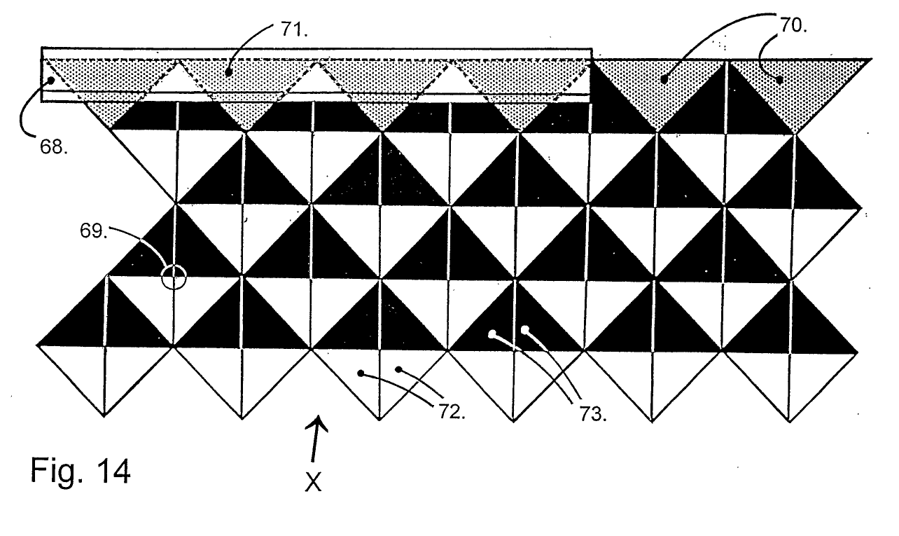

FIG. 12. presents a longitudinal exposure A.A. and reveals the undersides of the now marked in black sectors 62. and the thin black absorbent layer 64. it also reveals a smooth thin covering of transparent material 65. that covers layer 64. and extends over the whole dashboard with transparent material extending to the full depth of the inverted pyramids and protects the delicate absorbent textured surfaces of both the single layer 64. and the pyramid's surfaces.

FIG. 13 presents cross section B.B. from FIG. 12. and reveals a view of the dashboard from directly above, it also shows the alternating pattern which presented on an angle as FIG. 11 indicating the direction from which it was viewed with an arrow marked X. The forward positioned and angled absorbent only sector 66. indicates with dotted lines the concealed parts of the inverted pyramids 67. With all mirror sectors facing forward at angles reflections exit through the windscreen, some in divergent direction while others reflecting forward will rely on the windscreen's angle to prevent observation by the front seat occupants.

FIG. 14 Presents a downward view similar to that shown in FIG. 13 and presents a small section of a dashboard, it features an identical and near vertical sector 68 the details thereof are not shown in this drawing but can be seen in FIG. 12 as items 64 and 65, at the junction with the horizontal arrangement of the now introduced four sided inverted pyramids 69 the all absorbent sectors extend horizontally as a number of triangular shaped sections 70 and when obscured by 68 they are shown, within interrupted lines as 71 they extend to match the pattern of the all identically shaped pyramidal sectors that present two mirror surfaces 72 facing forward and shown as white surfaces and shown by the arrow marked X. indicating the viewed direction and two black absorbent surfaces 73. The size of the drawings are not indicative of the finished product and are only presented this large to help identify the functions, it will function regardless of size and may well suit production to be considerably smaller. The principle advantage of a four sided pyramidal arrangement is to present all forward facing surfaces to reflect radiation and including light, out through the windscreen at divergent angles.

### IN CONCLUSION

It would be impractical to list all the individual applications that would benefit from the disclosures unique features, the first being the permanent protection of extremely light absorbent textures that are commonly available for use in textiles such as velvet. Why such fabrics are not used and also why very matte surface textures rarely are used is due to ongoing deterioration and maintenance considerations. With such surfaces in intimate contact with either a solid or fluid physical transparent material this problem no longer exists as is the case also when a transparent layer is used, thus observation through transparent gaps or passageway spacing apart black surfaces will minimise specular interference.

In addition Glare or it's reflections can be controlled when natural and/or artificial light passes through articles to illuminate what so ever field is required, ranging from very narrow beams and all the way to a specific plane that remains unobserved above horizontal for example, alternately the same combination can present as a single black layer, protected by a transparent layer and only functions to absorb radiation.

The second unique feature utilises the ability of a surface to reflect light and preferably being Mirror, such surfaces can reflect in several directions simultaneously, thus the juxta positioning of black and mirror surfaces can be arranged, usually positioned with alternate finishes facing one another, will present a black surface directly or a reflection of black from the opposite surface, both performing the physical shielding function at any desired angle, including observation from within the normal field of view, the matte surface or it's reflection hiding the light source from view while light transmitted at shielded angles can provide additional illumination towards observed areas.

The second feature presents two options, one is to use a physical solid or fluid transparent material and this provides the refractive properties concerned, including directional change in transit, ability to utilise surface shapes to control ingress and egress directions and being a continuous surface weather proof or submersible products are feasible, alternately this same combination can present as a single layer that combines sections of black with a not necessarily equal sections of mirror, arranged in a convoluted form that prevent an observer viewing the mirror sections that present at angles to reflect impinging radiation back through an outer transparent protective exterior surface in divergent directions.

Another option presents both black and mirror surfaces, but gaps and passageways are left open to the atmosphere. The shielding functions now lack all continuous exterior surfaces advantages or directional changes including those in transit but retain the mirror surfaces dual functions and the capability to shield by use of reflective surfaces while increasing light output. The other missing advantage being a much more serviceably texture will be required, most likely a satin texture. A further open to atmosphere option that can apply uses a thin layer of transparent material and thus protect more absorbent surfaces but will generally require unobserved locations or surfaces that prevents or limits specular reflection. It is therefore claimed that any Shielding Articles using either one or both of the above unique principles should be considered as having been including in this disclosure.

1-18. (canceled)

19. A method of constructing a light shielding article, said method comprising the steps of providing at least one thin element defining at least one light absorbing surface and at least one light reflecting mirror surface, said light absorbing surface being spaced from and facing said light reflecting mirror surface, providing a transparent material between said surfaces, said transparent material being in contact with the respective said surfaces and defining between said surfaces, a passageway for the passage of light.

20. A method as claimed in claim 1 wherein said at least one element comprises at least one pair of spaced apart elements, one said element of said pair having said light absorbing surface and the other said element of said pair having said light reflective mirror surface.

21. A method as claimed in claim 20 wherein said at least one element comprises a plurality of spaced apart said elements having said transparent material between respective said elements to define a plurality of juxtaposed said passageways.

22. A method as claimed in claim 20 wherein said pair of planar comprise thin planar elements having a pair of opposite planar surfaces.

23. A method as claimed in claim 20 wherein said element comprises a spiral strip element having a light absorbing surface and a light reflective mirror surface on opposite sides thereof.

24. A method as claimed in claim 20 wherein said light absorbent surface comprises a light absorbent black surface.

25. A method as claimed in claim 24 wherein said light absorbent black surface and said transparent material have a common refractive index to prevent specular reflections between the junctions thereof.

26. A light shielding article having at least one thin element defining at least one light absorbing surface and at least one light reflecting mirror surface, said light absorbing surface being spaced from and facing said light reflecting mirror surface, and a transparent material between said surfaces, said transparent material being in contact with the respective said surfaces and defining between said surfaces, a passageway for the passage of light.

27. A light shielding article as claimed in claim 26 wherein said at least one element comprises at least one pair of spaced apart elements, one said element of said pair having said light absorbing surface and the other said element of said pair having said light reflective mirror surface.

28. A light shielding article as claimed in claim 26 wherein said at least one element comprises a plurality of spaced apart said elements having said transparent material between respective said elements to define a plurality of juxtaposed said passageways.

29. A light shielding article as claimed in claim 27 wherein said pair of elements comprise thin planar elements having a pair of opposite planar surfaces.

30. A light shielding article as claimed in claim 26 wherein said element comprises a spiral strip element having a light absorbing surface and a light reflective mirror surface on opposite sides thereof.

31. A light shielding article as claimed in claim 26 wherein said light absorbent surface comprises a light absorbent black surface.

32. A light shielding article as claimed in claim 31 wherein said light absorbent black surface and said transparent material have a common refractive index to prevent specular reflections between the junction thereof.

33. A light shielding article as claimed in claim 26, said light shielding article being adapted for observing a scene or subject matter therethrough externally of said article and within the normal field of view of an observer, said shielding article comprising a panel adapted to be supported in a substantially vertical attitude and having a first section comprising a plurality of substantially parallel substantially planar said thin elements and transparent material between respective pairs of said thin elements to define a series of juxtaposed passageways through said shielding article which allowing the transmission of light therethrough, each said element having and upper and lower surfaces comprising said light reflective and light absorbent surface respectively, said light reflecting surfaces being adapted to reflect external light away from said observer.

34. A light shielding article as claimed in claim 33 wherein said panel includes a second section below said first section, said second section comprising a transparent material permitting observation of said scene or subject matter through said panel.

35. A light shielding article as claimed in claim 34 wherein said second section further comprise a plurality of thin planar substantially parallel elements, said elements having opposite surfaces of a light absorbent material.

36. A light shielding article as claimed in claim 26 for controlling the passage of light from an artificial light source, said shielding article being adapted to be positioned between said light source and an observer, said article including said at least one said element defining said light absorbent surface and light reflecting mirror surface, said light absorbent surface being positioned in use relative to said light reflecting mirror surface and to said light source and said observer such as to prevent observation of said light source in the normal field of view of said observer and to permit said observer to observe directly said light absorbent surface or a reflection through said light reflecting mirror surface of said light absorbent surface.

37. A light shielding article as claimed in claim 36 wherein said light absorbent surface comprises a black surface.

38. A light shielding article as claimed in claim 36 wherein said light shielding article is adapted for use with a fluorescent lamp and includes a plurality of longitudinal said elements and a plurality of transverse said elements intersecting said longitudinal elements.

39. A light shielding article as claimed in claim 38 wherein said transverse elements extend relative to the longitudinal elements to form a plurality of open-ended cells of equilateral triangular cross section.

40. A light shielding article as claimed in claim 39 wherein the inner surfaces of each said equilateral triangular cell comprise a pair of light reflective mirror surfaces and a light absorbent surface.

41. A light shielding article as claimed in claim 38 wherein said transverse elements extend substantially at right angles to the longitudinal elements to form a plurality of open ended cells of square or rectangular cross section.

42. A light shielding article as claimed in claim 41 wherein the inner surfaces of each said square or rectangular cell comprise a pair of adjacent light absorbent surfaces and a pair of adjacent light reflective surfaces.

43. A light shielding article as claimed in claim 36 and wherein said elements comprise a plurality of frustonconical elements adapted to surround said artificial light source, each said frustoconcial element having an upper and lower surface, said upper surface comprising said light absorbent surface and said lower surface comprising said light reflective mirror surface.
